(19) United States
(12) Patent Application Publication
(10) Pub. No.: US 2026/0370124 A1
(43) Pub. Date: Nov. 19, 2026

(54) POWER MANAGEMENT INTEGRATED CIRCUIT AND ELECTRONIC DEVICE AND COMPUTING SYSTEM INCLUDING SAME

(71) Applicant: SAMSUNG ELECTRONICS CO., LTD., Suwon-si (KR)

(72) Inventors: Chaekyu CHOE, Suwon-si (KR); Yongjin KWON, Suwon-si (KR); Byungchan KIM, Suwon-si (KR); Jaehyun PARK, Suwon-si (KR); Jaejun LEE, Suwon-si (KR); Bonggeun CHUNG, Suwon-si (KR); Joohoon KIM, Suwon-si (KR)

(73) Assignee: SAMSUNG ELECTRONICS CO., LTD., Suwon-si (KR)

(21) Appl. No.: 19/388,183

(22) Filed: Nov. 13, 2025

(30) Foreign Application Priority Data
May 16, 2025 (KR) 10-2025-0064072

(51) Int. Cl. H02M 1/08; H02M 1/44; H02M 3/157; H02M 3/158

(52) U.S. Cl. CPC H02M 1/08; H02M 1/44; H02M 3/157; H02M 3/158

(57) ABSTRACT

A power management integrated circuit includes a DC‑DC converter configured to convert an input voltage into an output voltage and provide the output voltage to an output terminal, and a control logic circuit configured to control the DC‑DC converter. The DC‑DC converter includes a first switch configured to selectively connect or disconnect an electrical path between the input voltage and a switch node, an inductor connected between the switch node and the output terminal, and a first gate driver configured to apply a turn‑on signal or a turn‑off signal to a gate of the first switch, and wherein the control logic circuit is configured to, based on one or more predetermined conditions being satisfied, control the first gate driver to reduce a gate drive strength of the first switch caused by the turn‑on signal.

### CROSS-REFERENCE TO RELATED APPLICATION

This application claims priority to Korean Patent Application No. 10-2025-0064072, filed in the Korean Intellectual Property Office on May 16, 2025, the entire contents of which are hereby incorporated by reference.

### BACKGROUND

### 1. Field

The present disclosure relates to a power management integrated circuit, an electronic device including the same, and a computing system including the same.

### 2. Description of Related Art

A system-on-chip (SoC) refers to a technology that integrates, onto a single semiconductor integrated circuit, various functional blocks such as a central processing unit (CPU), a memory, interfaces, digital signal-processing circuits, and analog signal-processing circuits in order to implement a computing system or another electronic system, or to an integrated circuit (IC) fabricated in accordance with such technology. The SoC operates by receiving power from a power management integrated circuit and, to improve efficiency, the power management integrated circuit includes a plurality of converters that supply respective voltages to a plurality of power domains of the SoC.

### SUMMARY

The present disclosure provides a power management integrated circuit, an electronic device including the same, and a computing system including the same, which enhance the stability of circuit operation.

The technical challenges addressed by the present disclosure are not limited to those described above, and other challenges not expressly mentioned may be clearly understood by those of ordinary skill in the art from the following description of the disclosure.

In some embodiments, a power management integrated circuit includes a DC‑DC converter configured to convert an input voltage into an output voltage and provide the output voltage to an output terminal, and a control logic circuit configured to control the DC‑DC converter. The DC‑DC converter includes a first switch configured to selectively connect or disconnect an electrical path between the input voltage and a switch node, an inductor connected between the switch node and the output terminal, and a first gate driver configured to apply a turn‑on signal or a turn‑off signal to a gate of the first switch. The control logic circuit is configured to, based on one or more predetermined conditions being satisfied, control the first gate driver to reduce a gate drive strength of the first switch caused by the turn‑on signal.

In some embodiments, an electronic device includes a system on chip including a plurality of power domains, and a power management integrated circuit including a DC‑DC converter configured to convert an input voltage into an output voltage and provide the output voltage to any one of the plurality of power domains, and a control logic circuit configured to control the DC‑DC converter. The DC‑DC converter includes a switch configured to selectively connect or disconnect an electrical path between the input voltage and a switch node, an inductor connected between the switch node and an output terminal, and a gate driver configured to apply a turn‑on signal or a turn‑off signal to a gate of the switch. The control logic circuit is configured to, based on one or more predetermined conditions being satisfied, control the gate driver to reduce a gate drive strength of the switch caused by the turn‑on signal.

In some embodiments, a computing system includes a power management integrated circuit including a DC‑DC converter configured to convert an input voltage into an output voltage and provide the output voltage to an output terminal, and a control logic circuit configured to control the DC‑DC converter, and a host configured to control the power management integrated circuit based on an SCL (serial clock line) signal and an SDA (serial data line) signal synchronized with the SCL signal. The DC‑DC converter includes a switch configured to selectively connect or disconnect an electrical path between the input voltage and a switch node, an inductor connected between the switch node and the output terminal, and a gate driver configured to apply a turn‑on signal or a turn‑off signal to a gate of the switch. The control logic circuit is configured to, based on one or more predetermined conditions being satisfied, control the gate driver to reduce a gate drive strength of the switch caused by the turn‑on signal.

According to various embodiments of the present disclosure, by reducing the gate drive strength in response to predetermined conditions being satisfied, a peak magnitude of a noise current generated in the DC-DC converter may be reduced. Consequently, even if multiple DC-DC converters turn on simultaneously, ground bounce may be alleviated and malfunction probabilities of the power management integrated circuit and an entire system including the same may be lowered.

According to various embodiments of the present disclosure, electromagnetic interference (EMI) or noise that may occur during communication between a host and a power management integrated circuit (PMIC) may be continuously reduced.

According to various embodiments of the present disclosure, it is possible to reduce the likelihood of errors associated with an analog-to-digital converter (ADC) and, even if an error associated with an ADC occurs, the error may be promptly resolved.

According to various embodiments of the present disclosure, even when an input voltage of the DC-DC converter increases, noise of the DC-DC converter or the PMIC may be effectively suppressed.

According to various embodiments of the present disclosure, by reducing a gate drive strength when an inductor current exceeding a stable current range occurs, the stability of circuit operation may be improved.

The various useful advantages and effects of the present disclosure are not limited to those described above and will be more clearly understood in the course of describing specific embodiments of the disclosure.

### BRIEF DESCRIPTION OF THE DRAWINGS

FIG. 1 illustrates a computing system according to an embodiment of the present disclosure.

FIG. 2 illustrates a PMIC of the computing system of FIG. 1 and components associated with the PMIC.

FIG. 3 is a block diagram and circuit diagram illustrating one DC-DC converter among the plurality of DC-DC converters of FIG. 2.

FIG. 4 is a circuit diagram including a plurality of DC-DC converters that share an input power supply and a common ground according to an embodiment of the present disclosure.

FIG. 5 is a timing diagram illustratively showing ground noise currents that may occur during operation of the plurality of DC-DC converters of the circuit of FIG. 4.

FIG. 6 illustrates an example of a detailed structure of a gate driver according to an embodiment of the present disclosure.

FIG. 7 is a diagram for explaining a first condition for reducing a gate drive strength of the switch of FIG. 6.

FIG. 8 illustrates an example structure of a communication detection circuit of FIG. 7.

FIG. 9 is a timing diagram showing timing relationships of signals illustrated in FIG. 8.

FIG. 10 is a block diagram schematically illustrating sensing and control-related components inside a PMIC for explaining a second condition for reducing a gate drive strength of the switch of FIG. 6.

FIG. 11 illustrates a variation in an input voltage over time to explain a third condition for reducing a gate drive strength of the switch of FIG. 6.

FIG. 12 illustrates an example of a control circuit associated with a DC-DC converter for explaining a fourth condition for reducing a gate drive strength of a switch.

FIG. 13 illustrates an example of a sub-circuit within the gate-drive-strength control circuit of FIG. 12.

FIG. 14 is a timing diagram showing timing relationships among signals within the control circuit of FIG. 12.

### DETAILED DESCRIPTION

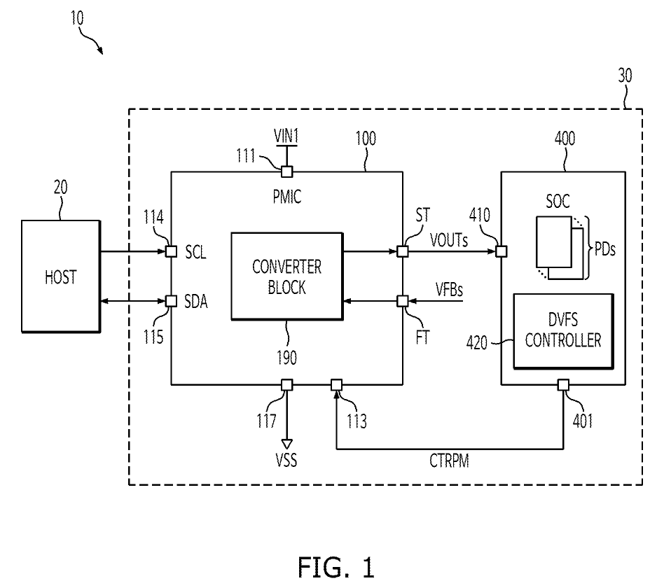

Hereinafter, various embodiments of the present disclosure will be described with reference to FIGS. 1 through 14. Throughout the entire specification, identical reference numerals refer to identical components.

FIG. 1 illustrates, by way of example, a computing system 10 according to an embodiment of the present disclosure.

Referring to FIG. 1, the computing system 10 may be implemented as various computing or mobile devices such as a mobile phone, a smart phone, a tablet personal computer (PC), a personal digital assistant (PDA), an enterprise digital assistant (EDA), a portable multimedia player (PMP), a digital camera, a music player, a portable game console, a navigation device, a wearable device, an Internet-of-Things (IoT) device, an Internet-of-Everything (IoE) device, an e-book, a virtual-reality (VR) device, or an augmented-reality (AR) device, etc.

The computing system 10 may include a host 20 and an electronic device 30, and the electronic device 30 may include a power management integrated circuit (PMIC) 100 and a system-on-chip (SoC) 400.

The SoC 400 is an example of a load to which the PMIC 100 supplies power, and the PMIC 100 of the present disclosure is not limited to supplying power only to the SoC 400. For example, the PMIC 100 may be designed to generate and manage a plurality of power rails necessary for various types of electronic circuits or systems, such as a microcontroller (MCU), a field-programmable gate array (FPGA), a system constituted by discrete integrated circuits, or a module performing a specific function. The PMIC 100 according to the present disclosure may supply and manage power not only to a core processing unit of a system but also to various functional blocks or load circuits, such as sensors, actuators, memories, and communication modules.

As a master device, the host 20 can communicate with the PMIC 100. For example, the host 20 may drive an SCL serial clock line and an SDA serial data line between the host 20 and the PMIC 100 based on, for example, a serial peripheral interface (SPI) protocol. The host 20 may transmit an SCL signal (for example, a clock signal) to the PMIC 100 through an SCL terminal 114 and may transmit an SDA signal (for example, a data signal) synchronized with the SCL signal to the PMIC 100 through an SDA terminal 115. The host 20 may control the PMIC 100 based on the SCL signal and the SDA signal.

The host 20 may indicate the start of communication by driving the SCL terminal 114 to a first logic state (for example, high) and driving the SDA terminal 115 from the first logic state to a second logic state (for example, low). The host 20 may transmit, through the SDA signal, address bits of the PMIC 100 and a read/write (R/W) bit indicating read or write, and may receive, from the PMIC 100, an SDA signal including an acknowledge (ACK) bit. Using the ACK bit, the host 20 may verify whether the address bits and the R/W bit have been successfully transmitted to the PMIC 100. The host 20 may indicate the end of communication by driving the SCL terminal 114 to the first logic state and driving the SDA terminal 115 from the second logic state to the first logic state.

As a slave device, the PMIC 100 can communicate with the host 20. The PMIC 100 may include an SCL terminal 114 that receives an SCL signal and an SDA terminal 115 that receives or outputs an SDA signal.

The PMIC 100 may include: an input-voltage terminal 111 that receives an input voltage VIN1; a general-purpose input/output (GPIO) terminal 113 that receives a power-management control signal CTRPM from outside the PMIC 100; a ground-voltage terminal 117 that receives a ground voltage VSS; switching pins ST that provide output voltages VOUTs; and feedback pins FT that receive feedback voltages VFBs. The PMIC 100 may include a converter block 190 that generates the output voltages VOUTs based on the input voltage VIN1 and provides the output voltages VOUTs to power domains PDs of the SoC 400. For example, the converter block 190 may provide each of the output voltages VOUTs to a respective one of the power domains PDs of the SoC 400.

The converter block 190 may include one or more DC-DC converters, and each of the one or more DC-DC converters may generate a respective one of the output voltages VOUTs. The PMIC 100 may provide the output voltages VOUTs to the power domains PDs through voltage terminals 410 of the SoC 400.

Each feedback voltage VFB may be a voltage that, for example, is fed back to the PMIC 100 from a load circuit, such as the SoC 400, that receives the output voltages VOUTs from the PMIC 100. For example, the output voltages VOUTs may be provided back to the PMIC 100, and each level of the feedback voltages VFBs may match a corresponding level of the output voltages VOUTs.

In another embodiment, each output voltage VOUT may not be provided to the PMIC 100 as-is but may be supplied to the PMIC 100 through a voltage divider or filter circuit including passive components (for example, resistors, capacitors, inductors). In this case, the voltage divider or filter circuit may be located on a substrate on which the PMIC 100 and the SoC 400 are mounted. Each level of the feedback voltages VFBs and each level of the output voltages VOUTs may be different.

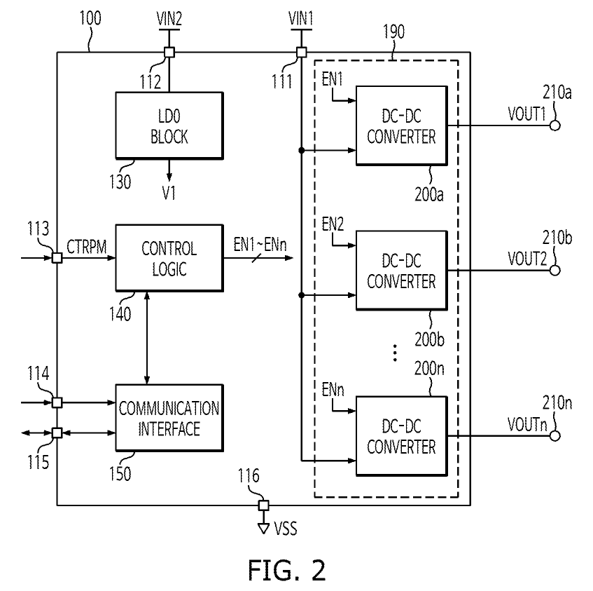

FIG. 2 illustrates the PMIC 100 of the computing system 10 of FIG. 1 and components associated with the PMIC 100.

Referring to FIG. 2, the PMIC 100 may include input-voltage terminals 111 and 112, the GPIO terminal 113, the SCL terminal 114, the SDA terminal 115, a ground terminal 116, an LDO (low-dropout) block 130, the control logic circuit 140, a communication interface 150, and the converter block 190. The PMIC 100 is not limited thereto and may omit some of the components illustrated in FIG. 2 or further include components not illustrated in FIG. 2.

The LDO block 130 may include an LDO regulator, receive a second input voltage VIN2, and generate an internal voltage VI based on the second input voltage VIN2. The LDO block 130 may provide the internal voltage VI to the control logic circuit 140 and the communication interface 150. The control logic circuit 140 and the communication interface 150 may operate based on the internal voltage VI.

The converter block 190 may include a plurality of DC-DC converters 200a-200n (where n is a natural number greater than or equal to 2) and output terminals 210a-210n. Each of the plurality of DC-DC converters 200a-200n may receive the first input voltage VIN1, generate a respective one of output voltages VOUT1-VOUTn, and provide the same to the outside through a respective one of the output terminals 210a-210n. For example, the output voltages VOUT1-VOUTn may correspond to the output voltages VOUTs of FIG. 1, and each of the output terminals 210a-210n may be connected to a respective one of the power domains PDs of the SoC 400 of FIG. 1.

The control logic circuit 140 may control the DC-DC converters 200a-200n. For example, the control logic circuit 140 may receive, through the GPIO terminal 113, the power-management control signal CTRPM from outside the PMIC 100 and may control activation and deactivation of the DC-DC converters 200a-200n based on the power-management control signal CTRPM.

The control logic circuit 140 may generate, based on the power-management control signal CTRPM, enable signals EN1-ENn and may provide the enable signals EN1-ENn to the DC-DC converters 200a-200n to individually control activation and deactivation of the respective DC-DC converters 200a-200n.

The communication interface 150 may be connected to an external host (for example, the host 20 of FIG. 1) through the SCL terminal 114 and the SDA terminal 115, and may transmit and receive signals and data. The communication interface 150 may transmit and receive signals with the control logic circuit 140. For example, the control logic circuit 140 may control the PMIC 100 according to host control based on signals received from the communication interface 150, and may transmit, through the communication interface 150, information received from the PMIC 100 or information associated with the PMIC 100 (for example, output current, output voltage, temperature, etc. of the PMIC 100) to the host.

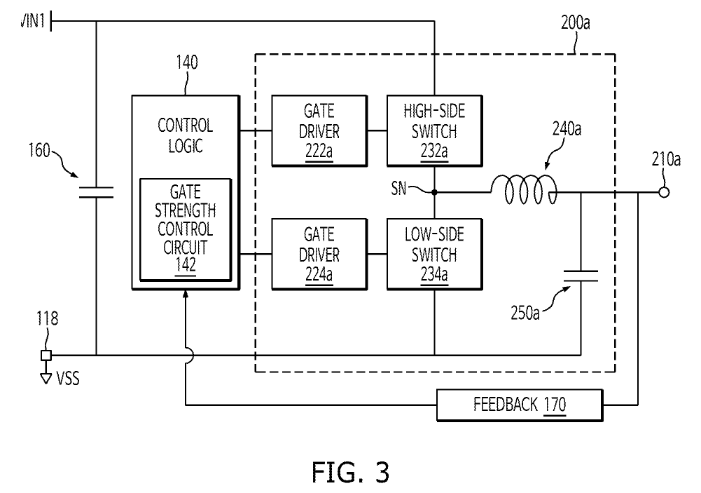

FIG. 3 is a block diagram and circuit diagram illustrating one DC-DC converter 200a among the plurality of DC-DC converters 200a-200n of FIG. 2. For convenience of explanation, FIG. 3 describes only one DC-DC converter 200a, but the disclosure is not limited thereto. For example, the DC-DC converter 200a illustrated and described with reference to FIG. 3 may be equally applied to each of the plurality of DC-DC converters 200a-200n of FIG. 2.

The DC-DC converter 200a may convert the input voltage VIN1 into an output voltage (for example, VOUT1 of FIG. 2) and provide the output voltage to the output terminal 210a.

A voltage-conversion process of the DC-DC converter 200a may be performed through switching elements and energy-storage elements. For example, a high-side switch 232a and a low-side switch 234a of the DC-DC converter 200a may alternately turn on and turn off, whereby a voltage provided to the output terminal 210a may be controlled.

The high-side switch 232a is connected between the input voltage VIN1 and a switch node SN and may selectively connect or disconnect an electrical path between the input voltage VIN1 and the switch node SN. The low-side switch 234a is connected between the switch node SN and a ground node 118 and may selectively connect or disconnect an electrical path between the switch node SN and the ground node 118. The switches 232a and 234a may be implemented as various types of semiconductor devices. For example, the switches 232a and 234a may be implemented as N-type and/or P-type MOSFETs. However, the disclosure is not limited thereto.

An inductor 240a is connected between the switch node SN and the output terminal 210a, and the inductor 240a and an output capacitor 250a together form an LC filter that mitigates or removes voltage ripple generated by switching operation and generates a smooth DC output voltage. On the input side, an input capacitor 160 may be connected to filter noise of the input-voltage line VIN1 or enhance stability.

The control logic circuit 140 may control the voltage-conversion process of the DC-DC converter 200a. The control logic circuit 140 may generate control signals (for example, pulse-width-modulated (PWM) signals) that determine turn-on and turn-off timings of the high-side switch 232a and the low-side switch 234a. For example, the control logic circuit 140 may generate control signals according to an operating state of the DC-DC converter 200a and a target output voltage.

Control signals generated by the control logic circuit 140 may be respectively supplied to a high-side gate driver 222a and a low-side gate driver 224a. Based on control signals received from the control logic circuit 140, the gate drivers 222a and 224a may generate drive signals (for example, turn-on or turn-off signals) that provide sufficient voltage and current for turning on or turning off the respective switches 232a and 234a, and may apply the generated drive signals to the gates of the switches 232a and 234a. The gate drivers 222a and 224a may be implemented as separate chips, may be integrated into a single chip, or may be integrated within the same semiconductor chip as the control logic circuit 140.

The control logic circuit 140 may, during a first interval of a switching period, turn on the high-side switch 232a and turn off the low-side switch 234a. In this case, current flows from the input voltage VIN1 through the high-side switch 232a and the switch node SN to the inductor 240a, whereby energy is stored, and simultaneously the output capacitor 250a is charged and current is supplied/provided to the output terminal 210a. During a second interval of the switching period, the control logic circuit 140 may turn off the high-side switch 232a and turn on the low-side switch 234a. In this case, energy stored in the inductor 240a is released, and current continues to flow by forming a closed loop through the switch node SN and the low-side switch 234a, and this current is supplied to the output capacitor 250a and the output terminal 210a. The control logic circuit 140 may synchronously drive the high-side switch 232a and the low-side switch 234a by repeating the above switching period.

To maintain the output voltage provided to the output terminal 210a at a desired target value, a closed-loop control method using a feedback loop 170 may be employed. For example, information related to the output voltage currently provided to the output terminal 210a may be delivered to the control logic circuit 140 through the feedback loop 170. For example, the feedback loop 170 may deliver the feedback voltages VFBs or information related to the feedback voltages VFBs to the control logic circuit 140.

In an embodiment, the control logic circuit 140 may compare information received through the feedback loop 170 with an internally set target voltage (for example, a reference voltage). If the output voltage provided to the output terminal 210a is lower than the target voltage, the control logic circuit 140 may determine that the output voltage should be increased; conversely, if the output voltage delivered to the output terminal 210a is higher than the target voltage, the control logic circuit 140 may determine that the output voltage should be decreased. Based on such determinations, the control logic circuit 140 may accurately regulate the output voltage delivered to the output terminal 210a to the target value in real time by adjusting, for example, a PWM duty cycle representing a ratio of turn-on to turn-off times of the switches 232a and 234a, even if a load current changes or the input voltage fluctuates.

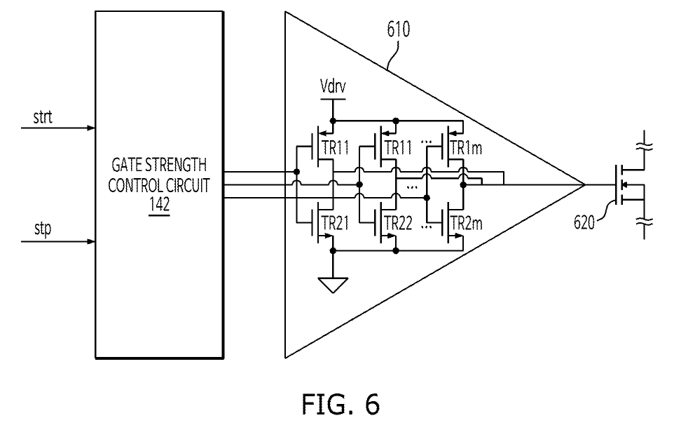

In various embodiments of the present disclosure, the control logic circuit 140 may include a gate-drive-strength control circuit 142. In another embodiment of the present disclosure, the gate-drive-strength control circuit 142 may be disposed outside the control logic circuit 140. The gate-drive-strength control circuit 142 may, based on one or more predetermined conditions being satisfied, control the gate drivers 222a and 224a and reduce a gate drive strength of the switches 232a and 234a caused by turn-on signals. Various conditions and embodiments in which the gate-drive-strength control circuit 142 reduces the gate drive strength of the switches 232a and 234a will be described in detail below with reference to FIGS. 6 through 14.

In the present specification, the gate-drive-strength control circuit 142 is described as reducing a gate drive strength of the switches 232a and 234a, but the disclosure is not limited thereto. For example, in another embodiment, the control logic circuit 140 may reduce a gate drive strength of the switches 232a and 234a without separately including the gate-drive-strength control circuit 142.

In FIG. 3, the DC-DC converter 200a is illustrated and described as including the high-side switch 232a and the low-side switch 234a, but the disclosure is not limited thereto. For example, the DC-DC converter 200a may be a converter that includes only a single switch (for example, only the high-side switch 232a) or operates in an asynchronous manner. For example, the DC-DC converter 200amay include only the high-side switch 232a and may configure the low side with a diode.

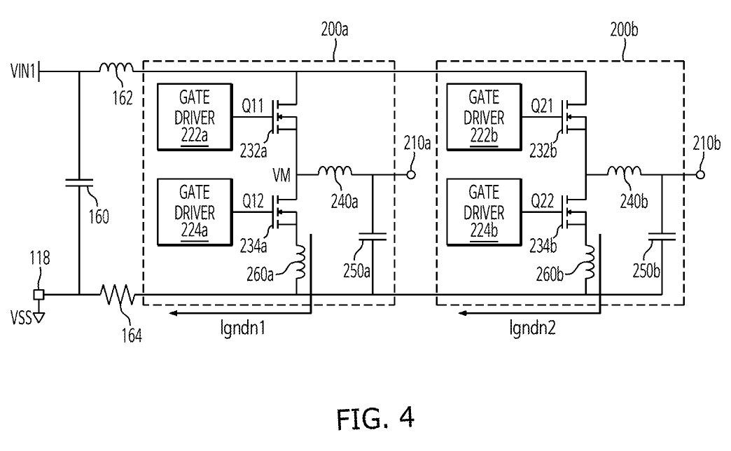

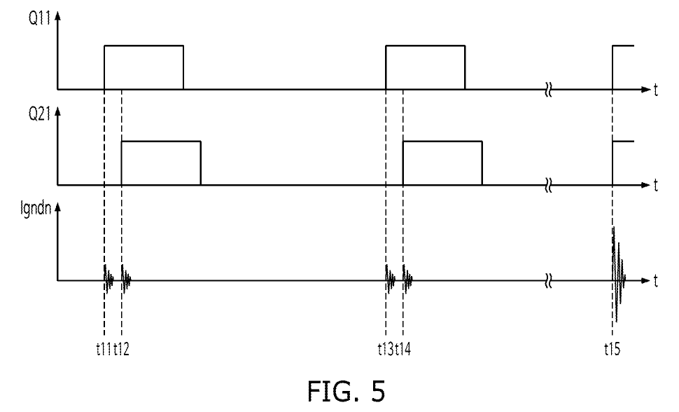

FIG. 4 is a circuit diagram including a plurality of DC-DC converters 200a and 200b that share an input power supply and a common ground according to an embodiment of the present disclosure. FIG. 5 is a timing diagram illustratively showing a ground noise current Igndn that may occur during operation of the plurality of DC-DC converters 200a and 200b of FIG. 4. FIGS. 4 and 5 may be referenced to explain a necessity to control, under certain conditions, a gate drive strength of the switches 232a, 232b, 234a, and 234b of the plurality of DC-DC converters 200a and 200b when the switches turn on.

Referring to FIGS. 2 and 4, in an embodiment, a first DC-DC converter 200a and a second DC-DC converter 200b, which are some of the plurality of DC-DC converters 200a-200nof FIG. 2, may receive the input voltage VIN1 through a common input line. An input capacitor 160 and an input inductor 162 for input filtering may be connected to the input line as needed.

The plurality of DC-DC converters 200a and 200b may each have a synchronous DC-DC converter structure that includes high-side switches 232a and 232b, low-side switches 234a and 234b, gate drivers 222a, 224a, 222b, and 224b that drive respective switches, and inductors 240a and 240b and capacitors 250a and 250b for output filtering. The plurality of DC-DC converters 200a and 200b may share a common ground voltage VSS, and a common ground path may include a parasitic resistance component 164 present in, for example, a board pattern, and parasitic inductance components 260a and 260b present in ground paths of the low-side switches 234a and 234b. Ground noise currents generated by switching operations of the first DC-DC converter 200a and the second DC-DC converter 200b may be referred to as a first ground noise current Igndn1 and a second ground noise current Igndn2, respectively.

Referring to FIG. 5, a high state of a waveform Q11 represents a state in which the high-side switch 232a of the first DC-DC converter 200a turns on, and a high state of a waveform Q21 represents a state in which the high-side switch 232b of the second DC-DC converter 200b turns on. The waveform Igndn represents a total noise current flowing through a common ground path of FIG. 4.

As can be seen from FIG. 5, individual noise-current spikes may be observed at times t11 and t13 when the high-side switch 232a of the first DC-DC converter 200a turns on and at times t12 and t14 when the high-side switch 232b of the second DC-DC converter 200b turns on.

At a time t15 when the high-side switches 232a and 232b of the plurality of DC-DC converters 200a and 200b turn on simultaneously, noise currents generated in the respective DC-DC converters 200a and 200b overlap to produce a noise-current spike having a larger peak value. Consequently, a ground-bounce phenomenon can occur in which a ground potential, which should be fixed, instantaneously rises due to the noise current. Ground noise and ground bounce that are amplified when multiple DC-DC converters 200a and 200b switch simultaneously can adversely affect the stability of an entire system. For example, ground bounce can degrade performance of sensitive analog circuits, cause data errors in digital communications, or lead to malfunctions of the PMIC itself or other load circuits connected thereto.

In particular, such noise and stability issues need to be considered more importantly when the PMIC operates under certain conditions that deviate from normal operating conditions. For example, although the input voltage VIN1 supplied to the PMIC is generally supplied stably through a pre-regulator, the PMIC itself may be required, at the design stage, to guarantee a wider operating-voltage range. For instance, a PMIC designed to operate at a nominal 12 V input may be required to withstand, without malfunction, a transient high input voltage, such as 15 V. In addition, from the perspective of output currents of converters, the PMIC may have an over-current-protection (OCP) level that protects itself from an overcurrent state in which a load current exceeds a normal maximum load current range. If a load current increases to the point of approaching the OCP level, this may indicate an abnormal condition in the system. Under such circumstances, stable operation and protection of the PMIC and the system may have priority.

Accordingly, according to various embodiments of the present disclosure, stability may be enhanced by adjusting an operating mode of the PMIC based on one or more predetermined conditions being satisfied as described above. The one or more predetermined conditions may correspond to conditions under which the PMIC may malfunction, abnormal operating conditions of the PMIC, conditions in which noise is likely to occur in a circuit, and/or conditions in which ensuring stability is prioritized.

When a predetermined condition is satisfied, the control logic circuit 140 may intentionally reduce a gate drive strength (for example, a turn-on speed) of the switches 232a, 232b, 234a, and 234b caused by turn-on signals by controlling the gate drivers 222a, 222b, 224a, and 224b. A gate drive strength of a switch 232a, 232b, 234a, or 234b may be a measure indicating how fast the switch switches. For example, by lowering the gate drive strength, the switch 232a turns on more slowly, reducing a rate of change of current di/dt at turn-on and thereby decreasing a peak magnitude of a noise current Igndn1 (for example, circuit noise generated by interference between wiring patterns) generated in the corresponding converter. Consequently, even if multiple converters turn on simultaneously, a magnitude of a total ground noise current Igndn may be reduced, ground bounce may be alleviated, and an entire-system malfunction probability may be lowered.

FIG. 6 illustrates an example of a detailed structure of a gate driver 610 according to an embodiment of the present disclosure.

The gate driver 610 may be connected to a switch 620. The switch 620 may be a high-side switch (for example, the high-side switch 232a of FIG. 3) or a low-side switch (for example, the low-side switch 234a of FIG. 3) of a DC-DC converter. In an example, the gate driver 610 may correspond to any one of the gate drivers 222a or 224b of FIG. 3.

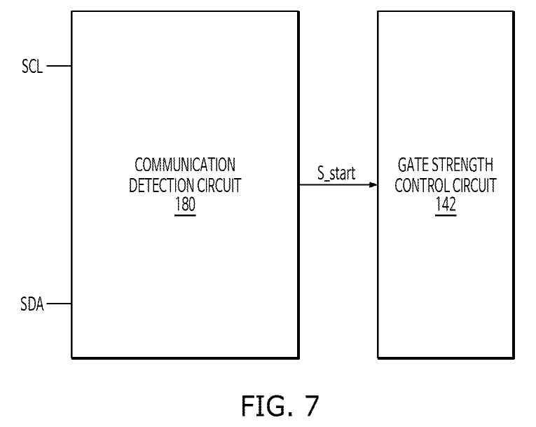

By controlling the gate driver 610, the gate-drive-strength control circuit 142 may control (for example, reduce or increase) a gate drive strength of the switch 620 caused by a turn-on signal. For example, the gate-drive-strength control circuit 142 may receive an initiation signal strt for starting an operation to reduce a gate drive strength, and, in response to receiving the initiation signal strt, may reduce a gate drive strength of the switch 620 caused by a turn-on signal by controlling the gate driver 610. The gate-drive-strength control circuit 142 may receive the initiation signal strt based on one or more predetermined conditions being satisfied and may reduce a gate drive strength of the switch 620 caused by a turn-on signal. The one or more predetermined conditions will be described in detail below with reference to FIGS. 7 through 14.

The gate-drive-strength control circuit 142 may receive a stop signal stp for stopping an operation to reduce a gate drive strength and, in response to receiving the stop signal stp, may increase (for example, restore) a gate drive strength of the switch 620 caused by a turn-on signal. The gate-drive-strength control circuit 142 may receive the stop signal stp based on one or more predetermined conditions not being satisfied or based on elapse of a predetermined time, and may increase a gate drive strength of the switch 620 caused by a turn-on signal.

The initiation signal strt and the stop signal stp may be physically separate signals, or may be implemented as a single signal whose meaning changes according to its state. In an example, the initiation signal strt and the stop signal stp are independent signals from each other and may be delivered through respective different paths. In this case, the initiation signal strt acts as a signal instructing a control target to start operation, and the stop signal stp acts as an independent signal instructing the control target to stop operation. In another example, the initiation signal strt and the stop signal stp may be delivered through a single signal line, and their meanings may be distinguished according to a level or state of the signal. For example, if the signal has a high level, it may be interpreted as the initiation signal strt, and if the signal has a low level, it may be interpreted as the stop signal stp.

The gate driver 610 may include first through m-th PMOS transistors TR11-TR1m (where m is a natural number greater than or equal to 2) and first through m-th NMOS transistors TR21-TR2m. One PMOS transistor (for example, the first PMOS transistor TR11) and one NMOS transistor (for example, the first NMOS transistor TR21) in the gate driver 610 may be referred to as a transistor pair, and the gate driver 610 may include m transistor pairs connected in parallel with one another.

For example, the first PMOS transistor TR11 and the first NMOS transistor TR21 may be referred to as a transistor pair. A first terminal of the first PMOS transistor TR11 is connected to a drive power supply Vdrv, a second terminal of the first PMOS transistor TR11 is connected to a second terminal of the first NMOS transistor TR21 and the gate of the switch 620, and the gate of the first PMOS transistor TR11 is connected to the gate-drive-strength control circuit 142 (or the control logic circuit 140) through a first common-gate line. A first terminal of the first NMOS transistor TR21 is connected to a ground power supply, a second terminal of the first NMOS transistor TR21 is connected to the second terminal of the first PMOS transistor TR11 and the gate of the switch 620, and the gate of the first NMOS transistor TR21 is connected to the gate-drive-strength control circuit 142 (or the control logic circuit 140) through the first common-gate line.

The second PMOS transistor TR12 and the second NMOS transistor TR22 may be referred to as a transistor pair. A first terminal of the second PMOS transistor TR12 is connected to the drive power supply Vdrv, a second terminal of the second PMOS transistor TR12 is connected to a second terminal of the second NMOS transistor TR22 and the gate of the switch 620, and the gate of the second PMOS transistor TR12 is connected to the gate-drive-strength control circuit 142 (or the control logic circuit 140) through a second common-gate line. A first terminal of the second NMOS transistor TR22 is connected to the ground power supply, a second terminal of the second NMOS transistor TR22 is connected to the second terminal of the second PMOS transistor TR12 and the gate of the switch 620, and the gate of the second NMOS transistor TR22 is connected to the gate-drive-strength control circuit 142 (or the control logic circuit 140) through the second common-gate line.

In a transistor pair, the gate of a PMOS transistor and the gate of an NMOS transistor may be connected to the gate-drive-strength control circuit 142 through a common-gate line. The gate-drive-strength control circuit 142 may be connected to gates of m transistor pairs through m common-gate lines.

Each of the first through m-th PMOS transistors TR11-TR1m may turn off when an NMOS transistor coupled through a common-gate line turns on, and may turn on when the NMOS transistor coupled through the common-gate line turns off. Likewise, each of the first through m-th NMOS transistors TR21-TR2m may turn off when a PMOS transistor coupled through a common-gate line turns on, and may turn on when the PMOS transistor coupled through the common-gate line turns off.

The gate-drive-strength control circuit 142 may reduce a gate drive strength of the switch 620 caused by a turn-on signal by reducing a current of the turn-on signal. For example, the gate-drive-strength control circuit 142 may reduce the gate drive strength of the switch 620 by turning on PMOS transistors only in a subset of the plurality of transistor pairs in the gate driver 610, thereby reducing a total current of the turn-on signal.

In an embodiment, the gate-drive-strength control circuit 142 may, based on one or more conditions for reducing a gate drive strength of the switch 620 not being satisfied, apply a low-level signal to x (where x is a natural number greater than or equal to 2 and not greater than m) of the m common-gate lines. Conversely, based on one or more conditions for reducing a gate drive strength of the switch 620 being satisfied, the gate-drive-strength control circuit 142 may apply a low-level signal to y (where y is a natural number less than x) of the m common-gate lines. For example, based on one or more conditions not being satisfied, the gate-drive-strength control circuit 142 may apply a low-level signal to a first common-gate line connected to the first PMOS transistor TR11 and the first NMOS transistor TR21 and to a second common-gate line connected to the second PMOS transistor TR12 and the second NMOS transistor TR22, and, based on one or more conditions being satisfied, may apply a high-level signal to the first common-gate line and a low-level signal to the second common-gate line.

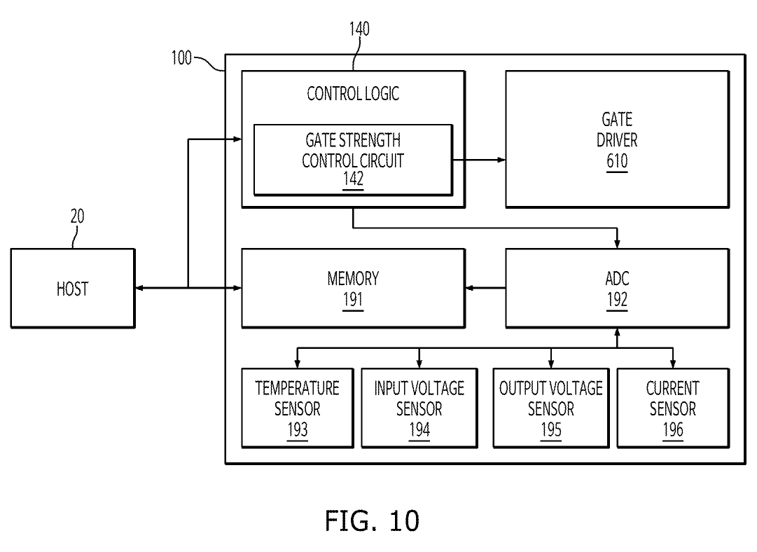

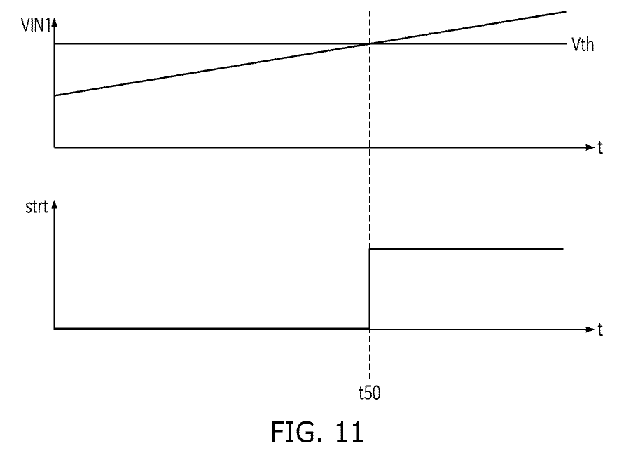

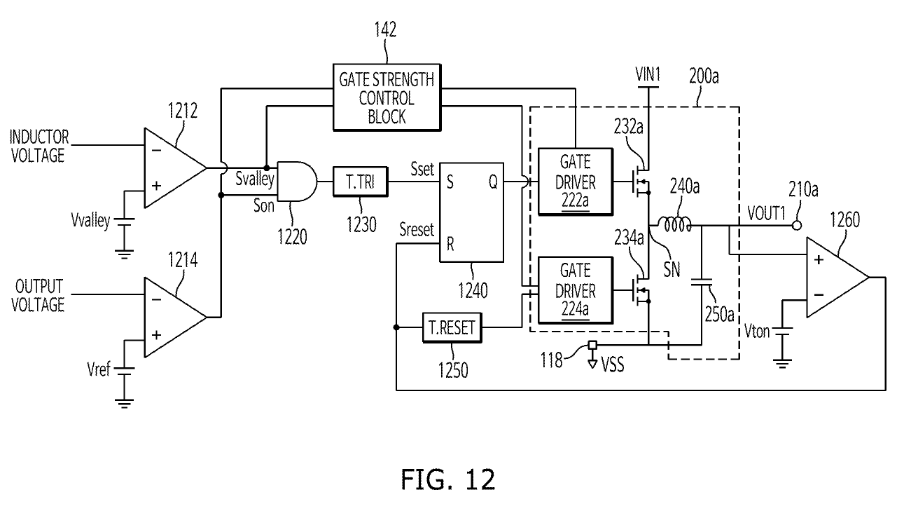

The gate-drive-strength control circuit 142 will be described in detail below with reference to FIGS. 7 through 9 for a first condition, to FIG. 10 for a second condition, to FIGS. 10 and 11 for a third condition, and to FIGS. 12 through 14 for a fourth condition, which are example conditions among the one or more predetermined conditions for reducing a gate drive strength of the switch 620 of FIG. 6. Ordinal numbers assigned to the first through fourth conditions are given for convenience of explanation and do not indicate priority or an order of application, and each of the first through fourth conditions may be an example condition included in the one or more predetermined conditions described above. Based on at least one of the one or more conditions being satisfied, the gate-drive-strength control circuit 142 may reduce a gate drive strength of the switch 620 of FIG. 6.

FIG. 7 is a diagram for explaining the first condition for reducing a gate drive strength of the switch 620 of FIG. 6.

Referring to FIGS. 1, 6, and 7, one condition among the one or more predetermined conditions for the gate-drive-strength control circuit 142 to reduce a gate drive strength of the switch 620 of FIG. 6 may include a first condition in which the PMIC 100 communicates with the host 20.

The PMIC 100 may include a communication detection circuit 180. The communication detection circuit 180 may determine whether a condition in which the PMIC 100 communicates with the host 20 is satisfied based on an SCL signal and an SDA signal synchronized with the SCL signal that are received from the host, and, based on the PMIC 100 communicating with the host 20, may transmit, to the gate-drive-strength control circuit 142, an initiation signal for initiating an operation to reduce a gate drive strength. For example, the communication detection circuit 180 may transmit a communication-start signal S_start having a high level based on the PMIC 100 communicating with the host 20, and the communication-start signal S_start having a high level may correspond to the initiation signal strt of FIG. 6.

Referring to FIGS. 6 and 7, in response to receiving the communication-start signal S_start (for example, the communication-start signal S_start having a high level) from the communication detection circuit 180, the gate-drive-strength control circuit 142 may reduce a gate drive strength of the switch 620 caused by a turn-on signal.

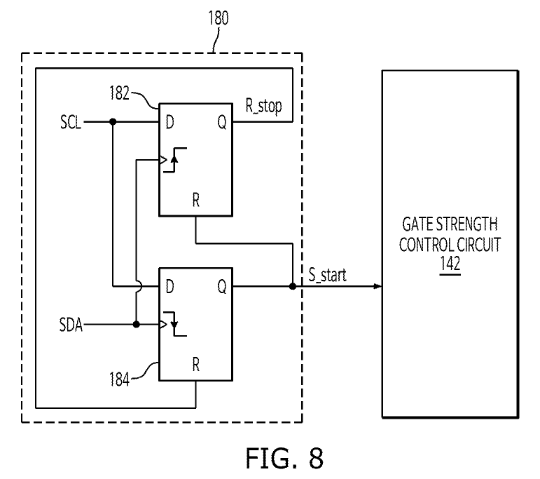

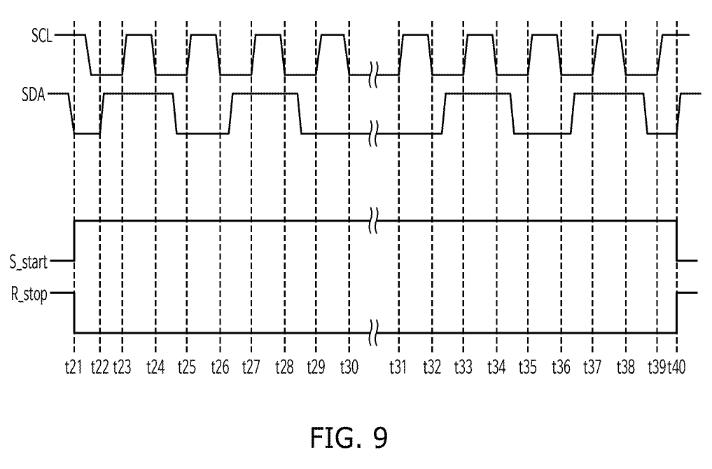

FIG. 8 illustrates an example structure of the communication detection circuit 180 of FIG. 7. FIG. 9 is a timing diagram showing timing relationships of signals illustrated in FIG. 8.

The communication detection circuit 180 may include a first D-flip-flop 182 configured to trigger and output an SCL signal in response to a rising edge of an SDA signal and a second D-flip-flop 184 configured to trigger and output an SCL signal in response to a falling edge of the SDA signal. For example, the first D-flip-flop 182 may latch a state of the SCL signal synchronized with a rising edge of the SDA signal and may output a communication-stop signal R_stop, and the second D-flip-flop 184 may latch a state of the SCL signal synchronized with a falling edge of the SDA signal and may output the communication-start signal S_start. The communication-start signal S_start (e.g., a high-level communication-start signal S_start) output from the second D-flip-flop 184 may be delivered to the gate-drive-strength control circuit 142 and may be used as a trigger signal for initiating an operation to adjust a gate drive strength during communication.

Referring to FIG. 9, to start communication with the PMIC 100, the host (for example, the host 20 of FIG. 1) may generate a start condition at a time t21 by maintaining an SCL signal at a first logic state (for example, a high level) and transitioning an SDA signal from the first logic state (high level) to a second logic state (low level).

Referring to FIGS. 8 and 9 together, when the start condition occurs, the second D-flip-flop 184 of FIG. 8 may latch the high-level SCL signal as a D input using a falling edge of the SDA signal as a clock. As a result, the communication-start signal S_start, which is a Q output of the second D-flip-flop 184, may transition to a high level at time t21. The communication-start signal S_start activated (for example, transitioned to a high level) may be applied to the gate-drive-strength control circuit 142 and may instruct the circuit to initiate an operation to reduce a gate drive strength. For example, the gate-drive-strength control circuit 142 may reduce a gate drive strength of a switch (for example, the switch 232a of FIG. 3) caused by a turn-on signal in response to a high-level signal output from the second D-flip-flop 184.

Continuing to refer to FIG. 9, following the start condition, the host may transmit address bits of the PMIC 100, an R/W bit indicating read or write, and the like through an SDA signal synchronized with the SCL signal, and may perform data communication such as receiving an ACK bit from the PMIC 100. During this period (for example, t22-t39), the communication detection circuit 180 may maintain the communication-start signal S_start at a high level. The gate-drive-strength control circuit 142 may maintain a reduced gate-drive-strength state during this period to continuously reduce EMI or noise that may occur during communication. During this period, the communication-stop signal R_stop may be maintained at a low level.

Referring again to FIGS. 8 and 9 together, when the host 20 wishes to end communication, it may generate a stop condition at a time t39 by maintaining the SCL signal at the first logic state (high level) and transitioning the SDA signal from the second logic state (low level) to the first logic state (high level). The first D-flip-flop 182 of FIG. 8 may latch the high-level SCL signal as a D input using a rising edge of the SDA signal as a clock. As a result, the communication-stop signal R_stop, which is a Q output of the first D-flip-flop 182, may transition to a high level at time t40 and become activated.

As shown in FIG. 8, the communication-stop signal R_stop, which is an output of the first D-flip-flop 182, may be connected to a reset terminal R of the second D-flip-flop 184. Therefore, when the communication-stop signal R_stop is activated at a high level at time t40, it may reset the second D-flip-flop 184. The communication-start signal S_start, which is a Q output of the reset second D-flip-flop 184, may transition to a low level at time t40 and become deactivated. Deactivation of the communication-start signal S_start may inform the gate-drive-strength control circuit 142 that communication has ended, thereby enabling subsequent actions such as restoring a gate drive strength to an original state.

As described above, the communication detection circuit 180 according to an embodiment of the present disclosure can accurately detect times at which communication with a host starts and ends using SCL and SDA signals according to the circuit configuration of FIG. 8 and the timing relationships of FIG. 9, and can efficiently perform a dynamic gate-drive-strength adjustment process linked to a communication state by generating the communication-start signal S_start (for example, a high-level signal) and delivering it to the gate-drive-strength control circuit 142.

FIG. 10 is a block diagram schematically illustrating sensing and control-related components inside the PMIC 100 for explaining the second condition for reducing a gate drive strength of the switch 620 of FIG. 6.

Referring to FIG. 10, the PMIC 100 may include the control logic circuit 140 and the gate driver 610 described above, and may further include a memory 191, an analog-to-digital converter (ADC) 192, and a plurality of sensors 193, 194, 195, and 196. The control logic circuit 140 may internally include the gate-drive-strength control circuit 142. Alternatively, the gate-drive-strength control circuit 142 may be located outside the control logic circuit 140.

The PMIC 100 may include the plurality of sensors 193, 194, 195, and 196 to identify an operating state of the PMIC 100 and/or surroundings. For example, the plurality of sensors 193, 194, 195, and 196 may detect specific physical quantities (temperature, voltage, current, etc.) associated with the PMIC 100 and may output analog signals proportional to the detected physical quantities. The ADC 192, configured to monitor a state of the PMIC 100, may convert analog detection signals output from the plurality of sensors 193, 194, 195, and 196 into digital values and may store the converted digital values in the memory 191. The memory 191 may be implemented as various types of storage devices such as registers or static random-access memory (SRAM). Additionally, the host 20 may access the memory 191 to read state information (for example, sensor values) of the PMIC 100 or to write operation-setting values (for example, a target output voltage).

The temperature sensor 193 may detect, measure, or sense a temperature of at least a portion of the PMIC 100. For example, the temperature sensor 193 may detect a temperature of a specific region inside the PMIC 100 or of the entire chip and may provide temperature information associated with the detected temperature. The ADC 192 may convert the temperature detected by the temperature sensor 193 into a digital value and may store the converted digital value in the memory 191.

The input-voltage sensor 194 may detect a level of an input voltage (for example, VIN1 of FIGS. 2 and 3) supplied to the PMIC 100. The ADC 192 may convert the input voltage detected by the input-voltage sensor 194 into a digital value and may store the converted digital value in the memory 191.

The output-voltage sensor 195 may detect, measure, or sense a level of at least one output voltage (for example, VOUT1-VOUTn of FIG. 2) generated by a DC-DC converter inside the PMIC 100. The ADC 192 may convert the output voltage detected by the output-voltage sensor 195 into a digital value and may store the converted digital value in the memory 191.

The current sensor 196 may detect, measure, or sense a magnitude of an output current provided to a specific output terminal (for example, the output terminal 210a of FIG. 2). The ADC 192 may convert an output-current value detected by the current sensor 196 into a digital value and may store the converted digital value in the memory 191.

The control logic circuit 140 may identify a current operating condition of the PMIC 100 in real time using values stored in the memory 191 or values directly delivered from the ADC 192. For example, the control logic circuit 140 may determine, based on a value obtained from the input-voltage sensor 194, whether the input voltage is abnormally high, may determine, based on a value obtained from the current sensor 196, whether an output current approaches an OCP level, or may determine, based on a value obtained from the temperature sensor 193, whether a chip temperature is close to an over-temperature state.

One of the one or more predetermined conditions for the gate-drive-strength control circuit 142 to reduce a gate drive strength of the switch 620 of FIG. 6 may include a second condition in which the control logic circuit 140 reads a value converted by the ADC 192 from the memory 191 or in which a value converted by the ADC 192 is written into the memory 191. Additionally or alternatively, one of the one or more predetermined conditions for the gate-drive-strength control circuit 142 to reduce a gate drive strength of the switch 620 of FIG. 6 may include a condition in which an error (for example, a read error, a conversion error, etc.) of the ADC 192 occurs.

Based on initiation of an operation in which the control logic circuit 140 reads a converted digital value from the memory 191, or based on a converted value being written into the memory 191 by the ADC 192, or based on occurrence of an error of the ADC 192, the control logic circuit 140 may adjust, through the gate-drive-strength control circuit 142, a signal delivered to the gate driver 610 to reduce a gate drive strength of a switch (for example, the switches 232a and 234a of FIG. 3) caused by a turn-on signal. Thus, a likelihood of an error associated with the ADC 192 may be reduced, and even if an error associated with the ADC 192 occurs, the error may be promptly resolved.

FIG. 11 illustrates a variation in the input voltage VIN1 over time to explain a third condition for reducing a gate drive strength of the switch 620 of FIG. 6.

Referring to FIGS. 6 and 11, one of the one or more predetermined conditions for the gate-drive-strength control circuit 142 to reduce a gate drive strength of the switch 620 of FIG. 6 may include a third condition in which the input voltage VIN1 input to the DC-DC converter including the switch 620 increases to be greater than or equal to a predetermined threshold voltage Vth.

Referring to FIGS. 6, 10, and 11, the input-voltage sensor 194 may detect a level of the input voltage VIN1, and the ADC 192 may convert the input voltage detected by the input-voltage sensor 194 into a digital value and may deliver the converted digital value to the control logic circuit 140. When the input voltage VIN1 increases, a ripple current of an inductor (for example, the inductor 240a of the DC-DC converter 200a) may increase to obtain the same output current as when the input voltage VIN1 was lower, and the increased ripple current may increase noise of the DC-DC converter.

The gate-drive-strength control circuit 142 may reduce a gate drive strength of the switch 620 caused by a turn-on signal based on an input voltage VIN1 detected by the input-voltage sensor 194 (or a digital value converted based on the input voltage VIN1 detected by the input-voltage sensor 194) increasing to be greater than or equal to the predetermined threshold voltage Vth at a time t50. For example, based on the input voltage VIN1 detected by the input-voltage sensor 194 increasing to be greater than or equal to the predetermined threshold voltage Vth at the time t50, an initiation signal strt may transition to a high level, and the gate-drive-strength control circuit 142 may reduce a gate drive strength of the switch 620 caused by a turn-on signal based on the initiation signal strt having transitioned to the high level. Accordingly, even when the input voltage VIN1 increases, noise of the DC-DC converter or the PMIC may be effectively suppressed.

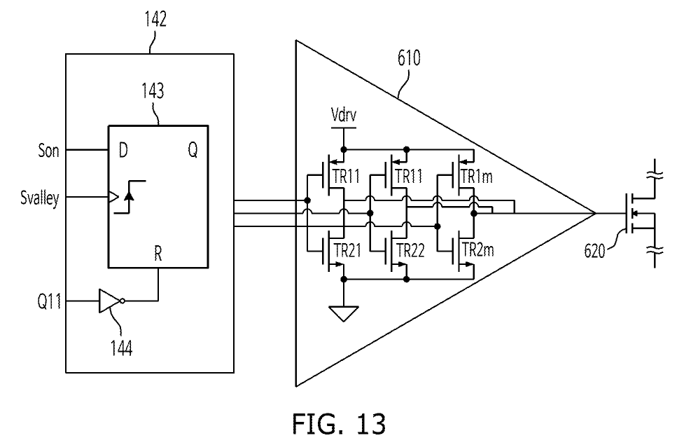

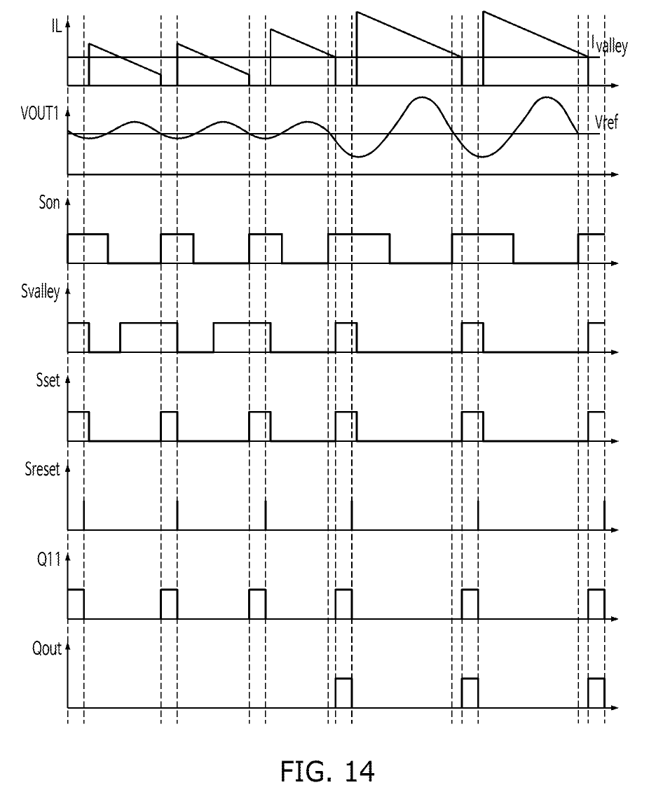

FIG. 12 illustrates an example of a control circuit associated with the DC-DC converter 200a for explaining the fourth condition for reducing a gate drive strength of the switches 232a and 234a. FIG. 13 illustrates an example of a sub-circuit within the gate-drive-strength control circuit 142 of FIG. 12. FIG. 14 is a timing diagram showing timing relationships among signals within the control circuit of FIG. 12. For convenience of explanation, FIGS. 12 through 14 describe the DC-DC converter 200a, but the disclosure is not limited thereto. For example, the circuit-structure examples associated with the DC-DC converter 200a illustrated and described with reference to FIGS. 12 through 14 may be implemented equally in each of the plurality of DC-DC converters 200a-200n of FIG. 2.

Referring to FIGS. 12 through 14, the control circuit associated with the DC-DC converter 200a illustrated in FIG. 12 may include a function of adjusting (for example, reducing) a gate drive strength of the high-side switch 232a and/or the low-side switch 234a according to a specific condition during a process of converting the input voltage VIN1 into an output voltage VOUT1 delivered to the output terminal 210a.

A main control loop for controlling switching operations of the DC-DC converter 200a may include comparators 1212 and 1214, an AND gate 1220, an SR latch 1240, an operational amplifier 1260, pulse generators 1230 and 1250, and gate drivers 222a and 224a.

Referring to FIGS. 12 and 14, the first comparator 1212 may compare a physical quantity associated with the inductor 240a with a predetermined threshold. For example, the first comparator 1212 may receive an inductor current IL of the inductor 240a and a threshold current Ivalley. The first comparator 1212 may output a low-level signal as a first-comparator output signal Svalley based on the inductor current IL (or voltage) being greater than the threshold current Ivalley (or threshold voltage Vvalley) and may output a high-level signal as the first-comparator output signal Svalley in response to the threshold current being greater than the inductor current. The first comparator 1212 may deliver the first-comparator output signal Svalley to the gate-drive-strength control circuit 142 and the AND gate 1220.

Referring to FIGS. 12 and 14, the second comparator 1214 may compare the output voltage VOUT1 delivered to the output terminal 210a with a reference voltage Vref and may output a result thereof. For example, the second comparator 1214 may receive the output voltage VOUT1 and the reference voltage Vref and may output a low-level signal as a second-comparator output signal Son in response to the output voltage VOUT1 being greater than the reference voltage Vref, and may output a high-level signal as the second-comparator output signal Son in response to the reference voltage Vref being greater than the output voltage VOUT1. The second comparator 1214 may deliver the second-comparator output signal Son to the gate-drive-strength control circuit 142 and the AND gate 1220.

Referring to FIGS. 12 and 14, the AND gate 1220 may logically AND the first-comparator output signal Svalley of the first comparator 1212 and the second-comparator output signal Son of the second comparator 1214 to generate a set signal Sset of the SR latch 1240. The pulse generator 1230 may receive the set signal Sset and may deliver a short-pulse set signal Sset to the SR latch 1240. The set signal Sset may set the SR latch 1240, causing a Q output to become a high-level signal. The Q output (for example, Q11 of FIG. 14) of the SR latch 1240 may control the high-side gate driver 222a to turn on the high-side switch 232a.

Referring to FIGS. 12 and 14, the operational amplifier 1260 may compare the output voltage VOUT1 with a threshold voltage Vton and may change an output of the operational amplifier 1260 to a high-level signal under a specific condition (for example, VOUT1 > Vton). The pulse generator 1250 may receive the output of the operational amplifier 1260 and may generate a short-pulse reset signal Sreset. The reset signal Sreset may reset the SR latch 1240, causing a Q output of the SR latch 1240 to become a low-level signal, which may cause the high-side switch 232a to turn off. The pulse generators 1230 and 1250 may provide pulse signals to reliably set or reset the latch under respective trigger conditions. The gate drivers 222aand 224bmay provide signals of sufficient power for driving the switches 232a and 234a according to outputs and control signals of the SR latch 1240 and the operational amplifier 1260.

One of the one or more predetermined conditions for the gate-drive-strength control circuit 142 to reduce gate drive strengths of the switches 232a and 234a may include a fourth condition in which a valley current of the inductor 240a is greater than or equal to a predetermined threshold current Ivalley. The valley current may refer to a current at an end of a descending interval of the inductor current IL of the inductor 240a within one switching cycle of the DC-DC converter 200a, that is, a minimum current of the inductor 240a within one switching cycle.

The gate-drive-strength control circuit 142 may determine, based on both the first-comparator output signal Svalley and the second-comparator output signal Son being high-level signals, that the valley current of the inductor 240a is greater than or equal to the threshold current Ivalley and may control the gate drivers 222aand 224ato reduce gate drive strengths of the switches 232a and 234a caused by turn-on signals. Consequently, by reducing a gate drive strength when a current exceeding a stable current range occurs, the stability of circuit operation may be enhanced.

Referring to FIGS. 12 and 13, the gate-drive-strength control circuit 142 may include a D-flip-flop 143 configured to trigger (by sampling D input) and output the second-comparator output signal Son in response to a rising edge of the first-comparator output signal Svalley.

The gate-drive-strength control circuit 142 may, based on the D-flip-flop 143 outputting a high-level signal, control the gate drivers 222a and 224a to reduce gate drive strengths of the switches 232a and 234a caused by turn-on signals. Referring further to FIG. 14, the gate-drive-strength control circuit 142 may reduce gate drive strengths of the switches 232aand 234a caused by turn-on signals based on an output Qout of the D-flip-flop 143 being a high-level signal. For example, the gate-drive-strength control circuit 142 may reduce a gate drive strength of the switches 232aand 234a from a first gate drive strength to a second gate drive strength.

Referring to FIGS. 13 and 14, the D-flip-flop 143 may receive an inverted signal of Q11, applied to the gate of the high-side switch 232a, as a reset signal, and may output a low-level signal based on a turn-off signal being applied to the gate of the high-side switch 232a. The gate-drive-strength control circuit 142 may, based on the output Qout of the D-flip-flop 143 being a low-level signal, increase gate drive strengths of the switches 232a and 234acaused by turn-on signals. For example, the gate-drive-strength control circuit 142 may increase a gate drive strength of the switches 232a and 234a from the second gate drive strength to the first gate drive strength.

To elaborate with reference to the timing diagram of FIG. 14, the D-flip-flop 143 may sample a state of the second comparator 1214 (that is, whether VOUT1 < Vref) at a rising edge of the first-comparator output signal Svalley (that is, a point in time at which the inductor current IL of the inductor 240a falls below the threshold current Ivalley). If the condition VOUT < Vref is satisfied at this point, so that the second-comparator output signal Son is at a high level, an output Q of the D-flip-flop 143 may be set to a high level.

The D-flip-flop 143 may receive, as a reset signal at a reset terminal R, an inverted signal (e.g., a signal inverted by the inverter 144) of the signal Q11 applied to the gate of the high-side switch 232a, and may be configured to output a low-level signal based on the turn-off signal being applied to the gate of the high-side switch 232a (that is, when the signal Q11 transitions to a low level). The gate-drive-strength control circuit 142 may, based on the low-level signal output from the D-flip-flop 143, increase (e.g., restore) the gate drive strength of the switches 232a and 234a caused by the turn-on signal from a second gate drive strength (e.g., reduced strength) to a first gate drive strength (e.g., normal strength). Referring to FIG. 14, when the drive signal Q11 of the high-side switch 232a transitions to the low level, a high-level signal passing through the inverter 144 may be applied to the reset terminal R of the D-flip-flop 143, thereby forcing the output of the D-flip-flop 143 to a low-level signal. Therefore, even when conditions for gate drive strength reduction are satisfied, the D-flip-flop 143 is reset at the end of the corresponding turn-on interval, allowing preparation for starting the next switching cycle again at the normal gate drive strength.

The present disclosure is not limited to the embodiments and the accompanying drawings described above. Various substitutions, modifications, and changes made by those of ordinary skill in the art without departing from the technical spirit of the present disclosure also fall within the scope of the present disclosure.

What is claimed is:

1. A power management integrated circuit comprising:
a DC‑DC converter configured to convert an input voltage into an output voltage and provide the output voltage to an output terminal; and
a control logic circuit configured to control the DC‑DC converter,
wherein the DC‑DC converter comprises:
a first switch configured to selectively connect or disconnect an electrical path between the input voltage and a switch node;
an inductor connected between the switch node and the output terminal; and
a first gate driver configured to apply a turn‑on signal or a turn‑off signal to a gate of the first switch, and
wherein the control logic circuit is configured to, based on one or more predetermined conditions being satisfied, control the first gate driver to reduce a gate drive strength of the first switch caused by the turn‑on signal.

2. The power management integrated circuit of claim 1, wherein the control logic circuit is further configured to control the first gate driver to reduce the gate drive strength of the first switch caused by the turn‑on signal by decreasing a current of the turn‑on signal.

3. The power management integrated circuit of claim 1, wherein the first gate driver comprises:
a first PMOS transistor (P1) having a first terminal of P1 connected to a drive power supply, a second terminal of P1 connected to the gate of the first switch, and a gate of P1 connected to the control logic circuit through a first common gate line;
a first NMOS transistor (N1) having a first terminal of N1 connected to a ground power supply, a second terminal of N1 connected to the gate of the first switch, and a gate of N1 connected to the control logic circuit through the first common gate line;
a second PMOS transistor (P2) having a first terminal of P2 connected to the drive power supply, a second terminal of P2 connected to the gate of the first switch, and a gate of P2 connected to the control logic circuit through a second common gate line; and
a second NMOS transistor (N2) having a first terminal of N2 connected to the ground power supply, a second terminal of N2 connected to the gate of the first switch, and a gate of N2 connected to the control logic circuit through the second common gate line.

4. The power management integrated circuit of claim 3, wherein the control logic circuit is further configured to:
based on the one or more predetermined conditions not being satisfied, apply a low‑level signal to the first common gate line and the second common gate line, and,
based on the one or more predetermined conditions being satisfied, apply a high‑level signal to the first common gate line and the low‑level signal to the second common gate line.

5. The power management integrated circuit of claim 1, wherein the one or more predetermined conditions include a condition that the power management integrated circuit communicates with a host.

6. The power management integrated circuit of claim 5, further comprising:
an SCL (serial clock line) terminal configured to receive an SCL signal from the host;
an SDA (serial data line) terminal configured to receive an SDA signal synchronized with the SCL signal; and
a communication detection circuit configured to determine, based on the SCL signal and the SDA signal, whether the condition that the power management integrated circuit communicates with the host is satisfied and, based on the power management integrated circuit communicating with the host being satisfied, transmit an initiation signal to the control logic circuit,
wherein the control logic circuit is further configured to, based on receiving the initiation signal, reduce the gate drive strength of the first switch caused by the turn‑on signal.

7. The power management integrated circuit of claim 6, wherein the communication detection circuit comprises:
a first D‑flip‑flop configured to trigger and output the SCL signal based on a rising edge of the SDA signal; and
a second D‑flip‑flop configured to trigger and output the SCL signal based on a falling edge of the SDA signal, and
wherein the control logic circuit is further configured to, based on the second D‑flip‑flop outputting a high‑level signal, reduce the gate drive strength of the first switch caused by the turn‑on signal.

8. The power management integrated circuit of claim 1, further comprising:
an analog‑to‑digital converter configured to monitor a state of the power management integrated circuit; and
a memory configured to store a value converted by the analog‑to‑digital converter,
wherein the one or more predetermined conditions include a condition that the control logic circuit reads the value converted by the analog‑to‑digital converter from the memory or a condition that the value converted by the analog‑to‑digital converter is written into the memory.

9. The power management integrated circuit of claim 8, further comprising a temperature sensor configured to detect a temperature of at least a part of the power management integrated circuit,
wherein the analog‑to‑digital converter is configured to convert the temperature detected by the temperature sensor into a converted digital value and store the converted digital value in the memory, and
wherein the control logic circuit is further configured to, based on an initiation of an operation in which the control logic circuit reads the converted digital value from the memory, reduce the gate drive strength of the first switch caused by the turn‑on signal.

10. The power management integrated circuit of claim 8, further comprising an output voltage sensor configured to detect the output voltage,
wherein the analog‑to‑digital converter is configured to convert the output voltage detected by the output voltage sensor into a converted digital value and store the converted digital value in the memory, and
wherein the control logic circuit is further configured to, based on initiation of an operation in which the control logic circuit reads the converted digital value from the memory, reduce the gate drive strength of the first switch caused by the turn‑on signal.

11. The power management integrated circuit of claim 8, further comprising a current sensor configured to detect an output current provided to the output terminal,
wherein the analog‑to‑digital converter is configured to convert the output current detected by the current sensor into a converted digital value and store the converted digital value in the memory, and
wherein the control logic circuit is further configured to, based on initiation of an operation in which the control logic circuit reads the converted digital value from the memory, reduce the gate drive strength of the first switch caused by the turn‑on signal.

12. The power management integrated circuit of claim 1, wherein the one or more predetermined conditions include a condition that the input voltage increases to be greater than or equal to a predetermined threshold voltage.

13. The power management integrated circuit of claim 12, further comprising:
an input voltage sensor configured to detect the input voltage;
a memory; and
an analog‑to‑digital converter configured to convert the input voltage detected by the input voltage sensor into a converted digital value and store the converted digital value in the memory,
wherein the control logic circuit is further configured to, based on the converted digital value increasing to be greater than or equal to the predetermined threshold voltage, reduce the gate drive strength of the first switch caused by the turn‑on signal.

14. The power management integrated circuit of claim 1, wherein the one or more predetermined conditions include a condition that a valley current of the inductor is greater than or equal to a predetermined threshold current.

15. The power management integrated circuit of claim 14, further comprising:
a first comparator configured to receive a current of the inductor and the predetermined threshold current, output a low‑level signal as a first comparator output signal based on the current of the inductor being greater than the predetermined threshold current, output a high‑level signal as the first comparator output signal based on the predetermined threshold current being greater than the current of the inductor, and provide the first comparator output signal to the control logic circuit; and
a second comparator configured to receive the output voltage and a reference voltage, output a low‑level signal as a second comparator output signal based on the output voltage being greater than the reference voltage, output a high‑level signal as the second comparator output signal based on the reference voltage being greater than the output voltage, and provide the second comparator output signal to the control logic circuit,
wherein the control logic circuit is configured to, based on both the first comparator output signal and the second comparator output signal being high‑level signals, determine that the valley current of the inductor is greater than or equal to the predetermined threshold current and control the first gate driver to reduce the gate drive strength of the first switch caused by the turn‑on signal.

16. The power management integrated circuit of claim 15, wherein the control logic circuit comprises a D‑flip‑flop configured to trigger and output the second comparator output signal based on a rising edge of the first comparator output signal, and
wherein the control logic circuit is further configured to, based on the D‑flip‑flop outputting a high‑level signal, control the first gate driver to reduce the gate drive strength of the first switch caused by the turn‑on signal from a first gate drive strength to a second gate drive strength.

17. The power management integrated circuit of claim 16, wherein the D‑flip‑flop is configured to receive, as a reset signal, an inverted signal of a signal applied to the gate of the first switch and output a low‑level signal based on the turn‑off signal being applied to the gate of the first switch, and
wherein the control logic circuit is further configured to, based on the D‑flip‑flop outputting the low‑level signal, increase the gate drive strength of the first switch caused by the turn‑on signal from the second gate drive strength to the first gate drive strength.

18. The power management integrated circuit of claim 1, further comprising:
a second switch configured to selectively connect or disconnect an electrical path between the switch node and a ground node; and
a second gate driver configured to apply the turn‑on signal or the turn‑off signal to a gate of the second switch,
wherein the control logic circuit is further configured to drive the first switch and the second switch synchronously.

19. An electronic device comprising:
a system on chip including a plurality of power domains; and
a power management integrated circuit comprising:
a DC‑DC converter configured to convert an input voltage into an output voltage and provide the output voltage to a power domain of the plurality of power domains; and
a control logic circuit configured to control the DC‑DC converter,
wherein the DC‑DC converter comprises:
a switch configured to selectively connect or disconnect an electrical path between the input voltage and a switch node;
an inductor connected between the switch node and an output terminal; and
a gate driver configured to apply a turn‑on signal or a turn‑off signal to a gate of the switch, and
wherein the control logic circuit is configured to, based on one or more predetermined conditions being satisfied, control the gate driver to reduce a gate drive strength of the switch caused by the turn‑on signal.

20. A computing system comprising:
a power management integrated circuit including a DC‑DC converter configured to convert an input voltage into an output voltage and provide the output voltage to an output terminal, and a control logic circuit configured to control the DC‑DC converter; and
a host configured to control the power management integrated circuit based on an SCL (serial clock line) signal and an SDA (serial data line) signal synchronized with the SCL signal,
wherein the DC‑DC converter comprises:
a switch configured to selectively connect or disconnect an electrical path between the input voltage and a switch node;
an inductor connected between the switch node and the output terminal; and
a gate driver configured to apply a turn‑on signal or a turn‑off signal to a gate of the switch, and
wherein the control logic circuit is configured to, based on one or more predetermined conditions being satisfied, control the gate driver to reduce a gate drive strength of the switch caused by the turn‑on signal.
